(19) United States
(12) Patent Application Publication
(10) Pub. No.: US 2026/0318137 A1
(43) Pub. Date: Oct. 15, 2026

(54) DOOR FOR ELEVATORS WITH A SHOCK ABSORBER DEVICE

(71) Applicant: ELECTROELSA SRL, Casole d'Elsa (IT)

(72) Inventor: Giorgio TALIANI, Poggibonsi (IT)

(21) Appl. No.: 19/120,020

(22) PCT Filed: Oct. 18, 2023
(86) PCT No.: PCT/EP2023/079069

§ 371 Date: Apr. 10, 2025

(30) Foreign Application Priority Data
Oct. 19, 2022 (EP) 22425049.8

(51) Int. Cl. E05F 3/04; B66B 13/24; B66B 13/30; E05D 15/16; E06B 3/44

(52) U.S. Cl. CPC E05F 3/04; E05D 15/16; E06B 3/4407; B66B 13/24; B66B 13/30; E05Y 2900/104; E05Y 2900/40

(57) ABSTRACT

A shock absorber for damping the travel of a leaf of a door for elevators is described. The shock absorber includes an abutment member to be struck by an actuation member and a shock absorber member to damp travel of the abutment member. A door for elevators equipped with a shock absorber is also described

### FIELD OF THE INVENTION

The present invention concerns a shock absorber device for a manually operated sliding door and a manually operated sliding door. In particular, the present invention concerns the field of doors for elevators, goods elevators, platforms or landing doors which are of the vertically sliding type, equipped with a counterweight or self-counterbalanced, such as for example double-leaf doors with opposite sliding in which the lower leaf also functions as a counterweight for the upper leaf, doors with a leaf and a ramp synchronized by a system of levers, in which a portion of the door that closes the gap is closed by a ramp that is lowered when the leaf is raised; it also concerns doors that slide horizontally.

This type of door is generally applied to elevators for construction sites but can also be used in elevators for civil applications in the industrial sector or in sliding gates which open manually.

### BACKGROUND OF THE INVENTION

Vertically sliding elevator doors equipped with a counterweight have been known for some time. These doors consist of a leaf inserted sliding into a frame whose upper end is open. The doors, which are mainly intended for construction site elevators, are not motorized and therefore have to be opened and closed by hand. For this purpose, considering that the leaf typically weighs in the order of 40-80 kg, the door provides counterweights to facilitate the lifting of the leaf by the operators.

There are also doors for elevators equipped with a double leaf, with a lower leaf that acts as a counterweight for an upper leaf, or doors with a leaf and a ramp synchronized by a system of levers in which a portion of the door that closes the gap is closed by means of the ramp which is lowered when the leaf is lifted. These types of doors may or may not have independent counterweights, but they function in a similar way because these doors are operated manually.

For safety reasons, elevator doors are equipped with an electric lock or a safety end-of-travel, which provides a body fixed to the frame and which contains the electrical components, and an actuator fixed on the leaf that slides upward when the door is opening, so that it is inserted in a suitable slot of the body when the leaf is in the closed position of the door.

In the case of a door with safety end-of-travel, there is always a mechanical interlock in parallel.

The safety electric lock has a double purpose: it serves to detect the presence or absence of the actuator in its slot and therefore to signal to an elevator control system whether the door is open or closed, preventing the elevator from moving if the door is open; it also serves to lock the actuator in position when there is no electric power supply to the electric lock. The lack of power to the electric lock can be voluntary due to the logic functioning of the plant, or involuntary due to the occurrence of some inconvenience. By locking the actuator in its slot, the leaf is also locked in the closed position, and this prevents people inside the elevator from getting off or falling.

One problem with known doors is that their manual actuation is often done in a violent and poorly controlled way. This is explained by the fact that they are driven by workers on construction sites who are not attentive to a controlled handling of the door leaf and who are also in a hurry. The effect of violent and uncontrolled drives is to cause the leaf to knock against the frame, accompanied by jolting of the counterweights; they also damage the safety electric lock or damage the safety end-of-travel.

The jolting of the counterweights can damage the entire structure of the door and/or elevator, in particular as time passes. Damage to the electric lock results in the elevator being blocked because either the door is kept in the closed position and the elevator cannot be accessed, or the door is kept in the open position and it cannot be moved.

It is not convenient to overcome these disadvantages with an oversizing of the parts because the components of the doors themselves have a transitory characteristic, that is to say, they have to be assembled and disassembled in different sites. Furthermore, they are elements of a lifting machinery, that is, an elevator or a platform, and therefore their weight affects the energy consumption of the machinery.

A shock absorber device is known from WO-A1-2006/111032, which comprises a V-shaped lever attached to a gas pressure spring provided upstream the slider with respect to the damping direction. It descends that damping of the movement of the leaf of the door is performed by the extension of the gas pressure spring. It is also noted that the shock absorber device is disclosed on a horizontally movable sliding door, but it is not suitable to be mounted on a vertically sliding door.

EP-A1-4019727 discloses a shock absorber device that has the same functioning and the same drawbacks of the shock absorber of WO-A1-2006/111032, which is mounted on a horizontally sliding door as well.

There is therefore a need to perfect a shock absorber device as well as an elevator door, which can overcome at least one of the disadvantages of the state of the art.

To do this, it is necessary to solve the technical problem of producing an elevator door that can be operated by hand even in a violent and uncontrolled way but that does not damage the accessories such as, in particular, counterweights and safety electric lock.

In particular, one purpose of the present invention is to provide a door for elevators that allows to automatically control the leaf's travel so that it does not cause damage to the accessories.

Another purpose of the present invention is to provide a shock absorber device for an elevator that is able to withstand repeated stresses due to the movement of the leaf, without being damaged.

Another purpose of the present invention is to provide a shock absorber device for an elevator which is compact and easy to implement on new doors as well as on existing doors.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, a shock absorber device according to the present invention for damping the travel of a leaf of a door comprises an abutment member, such as for example a slider, configured to be struck by an actuation member, and a shock absorber member associated with the abutment member. The shock absorber member is configured to damp the travel of the abutment member in a damping direction. The damping direction is the direction of the travel of the leaf (and of the actuation member) which has to be damped.

In particular, the shock absorber device is provided to damp the travel of a leaf of a door for elevators, goods elevators, platforms or landing doors, more specifically of the sliding and manually operated type.

In accordance with one aspect of the invention, the abutment member is pivoting between a rest position, in which it is inclined with respect to the damping direction, and an engagement position, in which it is aligned with the damping direction.

This configuration allows to automatically release the actuation member from the slider when the latter reaches its rest position, and conversely to engage the slider with the actuation member so as to be able to displace it in both senses in the damping direction.

In accordance with embodiments, the shock absorber member is placed downstream of the abutment member with respect to the damping direction.

Preferably, the shock absorber member is a pure absorber. Such as a unidirectional dissipator. In particular, the shock absorber member can be a hydraulic shock absorber, wherein the absorber fluid is advantageously oil. This kind of shock absorber member maintains the same behavior even if placed at hot or cold temperatures, contrarily to the gas pressure springs, for example. It has also a greater dampening capacity than gas pressure springs, which are not suitable to dampen leaves such as in vertical sliding doors operated manually.

According to some embodiments, the shock absorber device also comprises guide means to guide the displacement of the abutment member both during a step of damping the travel of a leaf, and also during a step in which the abutment member returns to its free position.

Advantageously, the guide means of the shock absorber device are configured to operate the pivoting of the slider toward its rest position. Preferably, the guide means comprise at least one guide slot containing a first rectilinear segment parallel to the damping direction, and a second segment inclined with respect to the first segment and preferably curved toward the first segment. The second segment is positioned at one end of the first segment. Advantageously, the shock absorber member is located at or beyond the other end of the first segment, so as to be downstream the abutment member with respect to the damping direction.

Advantageously, the slider is equipped with two guide rods configured to engage the same guide slot. Such guide rods are advantageously reciprocally distanced by a distance greater than the length of the second segment of the guide slot, so that when a first rod is at the bottom of the second segment of the guide slot, the other rod is in the first segment of the guide slot. That is, one of the two rods always remains in the first segment of the guide slot.

According to some embodiments, the abutment member has a first actuation surface configured to be engaged by the actuation member when the abutment member is in its rest position or in its engagement position.

Advantageously, the abutment member comprises a second actuation surface, configured to be engaged by the actuation member only when the abutment member is in its engagement position. Preferably, the second actuation surface is parallel to the first actuation surface. More preferably, the second actuation surface faces the first actuation surface.

According to some embodiments, when the abutment member is in the engagement position, the first actuation surface is perpendicular to the damping direction. Preferably, when the abutment member is in the engagement position, the second actuation surface is also perpendicular to the damping direction.

According to some embodiments, the abutment member comprises a mobile body on which the second actuation surface is positioned, the mobile body also comprising a surface inclined with respect to the perpendicular of the second actuation surface in such a way as to form an angle smaller than 90° with it. The abutment member also comprises a return member, for example a spring, connected both to the mobile body as well as to the slider, and configured to keep the mobile body in an active position. In this active position, the second actuation surface is parallel to the first actuation surface, that is, it is configured to be engaged by the actuation member.

According to some embodiments, the shock absorber device also comprises a return member connected to the abutment member and located parallel to the damping direction. Advantageously, the return member is of the traction type. In this way, the return member, preferably a traction spring, is configured to exert traction on the abutment member in the direction of the travel to be damped.

In accordance with some embodiments, the shock absorber device comprises a hollow body inside which the slider and the shock absorber member are positioned. The body also comprises the guide slot, made therein, and a rectilinear slot in which the first actuation surface and the second actuation surface are disposed.

In accordance with another aspect of the present invention, the actuation member comprises an interference portion configured to interfere with the shock absorber device, in particular with the slider, more in particular with the first and second actuation surfaces of the slider.

According to some embodiments, the abutment member and the actuation member are made of metal. In this way, they are suitable to withstand the weights and stresses inherent in the displacement of the leaf, regardless of the force used by the operator to displace it. Advantageously, the hollow body is also made of metal.

In accordance with another aspect of the present invention, a door comprises a frame and a leaf inserted sliding inside the frame so as to be displaced manually between an open position, in which the leaf leaves a free space within the frame, and a closed position, in which the leaf is inserted in the frame all the way. Advantageously, the door also comprises a safety electric lock attached to the frame, and a corresponding actuation member attached to the leaf and configured to be inserted in the electric lock when the leaf is in the closed position. That is, the door also comprises, also advantageously, a safety end-of-travel attached to the frame together with a mechanical interlock and a corresponding member for actuating the mechanical interlock attached to the leaf and configured to couple with the body of the frame when the leaf is in the closure position.

In particular, the door according to the present invention is a door for elevators, goods elevators, platforms or landing doors. The door can be of the vertical type, i.e. the leaf can be movable vertically.

According to some embodiments, the door also comprises at least one counterweight mean connected to the leaf in order to partly balance its weight and thus allow an easier displacement of the leaf toward its open position. The counterweight mean can comprise a pair of counterweights. Alternatively, the counterweight mean can comprise a second leaf, located below or to the side of the leaf as above, so as to form a double-leaf door.

In accordance with one aspect of the present invention, the door comprises at least one shock absorber device configured to damp the leaf's travel when it is displaced from the open position toward the closed position, and an actuation member configured to actuate the shock absorber device.

The idea behind the present invention is to separate the leaf's travel into two separate phases, a first free travel phase in which the operator who closes the door can act even with excessive force, and a second controlled travel phase, that is, damped travel, of the leaf when it reaches its closed position. In the case of doors with a vertically sliding leaf, the closed position of the door is obtained when the leaf is in a lowered position in the frame, and the damped travel is the descent of the leaf toward its lowered position, in which it closes the door.

By doing so, the present invention allows, without any intervention by an operator, to prevent the leaf from hitting against the frame and causing jolts of the counterweights. Furthermore, damage to the electric lock or to the safety end-of-travel is prevented, and therefore all the resulting locks. Furthermore, since a first phase of free descent of the leaf is allowed, the mode of use for the operator does not change compared to the doors of the state of the art. Therefore, the elevator door according to the invention allows to damp the leaf's travel without however slowing down the operator in his/her work.

The door of the present invention is not equipped with any drive member to open or close the door, the displacement of the leaf is performed manually.

Advantageously, the shock absorber device is configured to damp only a part of the travel of the leaf toward its closed position, preferably the last part of the leaf's travel. The last part of the descent is understood as at most the last 20 cm of the leaf's travel, preferably at most the last 15 cm of the leaf's travel, more preferably at most the last 12 cm of the leaf's travel, even more preferably at most the last 10 cm of the downward travel of the leaf.

According to some embodiments, the shock absorber device is configured in such a way as to be actuated by the actuation member when the descent of the leaf is to be damped only in said last part of the descent. Such a configuration is achieved, for example, by positioning in a predetermined manner both the shock absorber device on the frame and also the actuation member on the leaf.

In accordance with some embodiments, the shock absorber device is attached to the frame and the actuation member is attached to the leaf.

According to some embodiments, the shock absorber device comprises a hydraulic or pneumatic shock absorber member, in particular a shock absorber member of the type comprising a piston and a cylinder.

According to some embodiments, the elevator door comprises a second shock absorber device, configured to damp the leaf's travel when it is displaced from the closed position to the open position, and a second actuation member configured to actuate the second shock absorber device. Preferably, the second shock absorber device is configured to damp only a part of the travel of the leaf toward its open position, preferably the last part of the leaf's travel. The last part of the ascent is understood as at most the last 20 cm of the leaf's travel, preferably at most the last 15 cm of the leaf's travel, more preferably at most the last 12 cm of the leaf's travel, even more preferably the last at most the last 10 cm of the upward travel of the leaf.

Preferably, the second shock absorber device is identical to the first shock absorber device. More preferably, the second actuation member is also identical to the first actuation member. Advantageously, the second shock absorber device is overturned with respect to the first shock absorber device.

According to some embodiments, the shock absorber device is as described above.

### DESCRIPTION OF THE DRAWINGS

These and other aspects, characteristics and advantages of the present invention will become apparent from the following description of some embodiments, given as a non-restrictive example with reference to the attached drawings wherein:

FIGS. 1 and 2 are a front view and a three-dimensional view, respectively, of an elevator door according to the present invention, in a closed configuration;

FIG. 3 is a front view of the elevator door of FIGS. 1 and 2, in an open configuration;

FIG. 4 is a three-dimensional view of a shock absorber device according to the present invention;

FIG. 5 is a three-dimensional view of a part of the components of the shock absorber device of FIG. 4;

FIGS. 6 and 7 are a three-dimensional view and a lateral view, respectively, of a slider of the shock absorber device of FIG. 4;

FIGS. 8a-8d are lateral views of a detail of the shock absorber device of FIG. 4 in a sequence of operating configurations;

FIGS. 9 and 10 are a front view and a three-dimensional view, respectively, of an elevator door according to a variant of the present invention, in a closed configuration.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

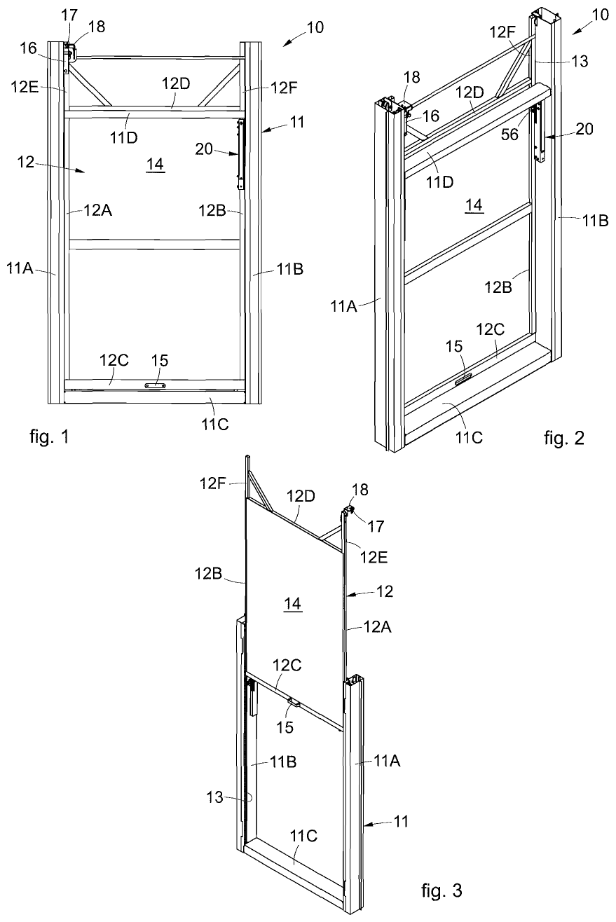

With reference to FIG. 1, a door 10 for elevators according to the present invention comprises a frame 11 in which a leaf 12 is inserted sliding. The frame 11 is of a known type and is equipped with two lateral profiles 11A, 11B reciprocally connected by a lower profile 11C and in which corresponding longitudinal guide grooves 13 are made in order to allow the leaf 12 to slide in a direction that is longitudinal to the lateral profiles 11A, 11B, that is, in a vertical direction during use. Obviously, the guide grooves 13 are located on the internal side of the lateral profiles 11A, 11B, that is, their side facing the inside of the door 10 (FIGS. 1, 2 and 3).

The frame 11 also comprises an upper profile 11D the width of which is smaller than the width of the other profiles 11A, 11B, 11C, and which is located in such a way as not to cover or obstruct the guide grooves 13, thus allowing the leaf 12 to pass. The profiles 11A, 11B, 11C, 11D are made of metallic material.

The door 10 also comprises counterweights connected to the leaf 12 in order to facilitate its lifting, which is done manually. The counterweights are positioned sliding inside the lateral profiles 11A, 11B, which are provided hollow.

The leaf 12, also made of metallic material, consists of a metal plate 14 and four support profiles 12A-D in correspondence with its edges, in particular two lateral support profiles 12A, 12B, one lower support profile 12C and one upper support profile 12D (FIGS. 1 and 2). The lateral support profiles 12A, 12B are each inserted sliding in a corresponding guide groove 13, so that the leaf 12 is sliding along them, therefore in a longitudinal direction to the lateral profiles 11A, 11B.

The lateral support profiles 12A, 12B have a length greater than that of the plate 14, so as to have an upper extremal portion 12E, 12F protruding therefrom. The use of the upper extremal portions will be described below.

The leaf 12 is sliding vertically between a completely lowered position in which the door 10 is closed (FIGS. 1 and 2) and a raised position in which the door 10 is open and operators are allowed to pass through the door 10 (FIG. 3). The door 10 is not provided with any drive member to move the leaf 12, which is therefore displaced manually by the operators. For this purpose, the leaf 12 is equipped with a handle 15, located here in a substantially central position on the lower support profile 12C. It is obviously possible to provide one or more additional handles, or to position the handle 15 in another position on the leaf 12.

The door 10 is also equipped with a safety electric lock 16 located in correspondence with the upper end of a lateral profile 11A, on its internal surface, in such a way as to be oriented toward the leaf 12. To actuate the safety electric lock 16, there is provided an actuation member 17 located at the upper end of the upper extremal portion 12E of the lateral support profile 12A, in correspondence with the lateral profile 11A there is located the safety electric lock 16, oriented toward the latter in such a way as to interfere with it (FIGS. 1, 2 and 3). One can deduce that when the door 10 is in the closed configuration, that is, with the leaf 12 lowered, the actuation member 17 is located precisely in correspondence with the electric lock 16, more particularly with an insertion seating thereof, in order to actuate the electric lock.

In particular, the actuation member 17 comprises a shaped tooth element carried by a bearing plate 18 which is, in turn, attached to the upper end of the extremal portion 12E of the lateral support profile 12A. The electric lock 16 and the shaped tooth 17 are positioned in such a way that the latter is automatically inserted into the seating in the electric lock when the leaf 12 is in the lowered closed position (FIGS. 1 and 2).

The door 10 also comprises a shock absorber device 20 attached to the internal surface of one 11B of the lateral profiles 11A, 11B of the frame 11 and configured to damp the movement of the leaf 12 during its descent, in particular during the last part of its descent (FIGS. 1, 2 and 3). The shock absorber device is therefore configured to damp the travel of the leaf 12 in a damping direction which, in the illustrated example, is downward. More precisely, the shock absorber device 20 is located longitudinally to the leaf 12 and flush with the corresponding lateral support profile 12B (FIG. 2). In the example shown, the shock absorber device 20 is positioned directly underneath the upper profile 11D, that is, in correspondence with the upper lateral corner of the plate 14. It is possible to provide other heights for the positioning of the shock absorber device 20.

The shock absorber device 20 comprises an external tubular body 21 (FIGS. 1, 2, 3 and 4) with a substantially rectangular section, inside which the components that allow to damp the movement of the leaf 12 are housed (FIG. 5).

The tubular body 21 houses a slider 22, which acts as an abutment member, a shock absorber 23 equipped with piston 23A and cylinder 23B and a traction spring 24 with a helical shape. The shock absorber 23 and the traction spring 24 are disposed longitudinally to the axis of development of the tubular body 21. It is to be observed that the shock absorber 23 is placed under the slider 22, i.e. downstream the slider 22 with respect to the damping direction. The traction spring 24 is placed downstream the slider 22 with respect to the damping direction as well. The slider 22 is attached to the free end of the piston 23A and also to one end of the traction spring 24. The free end of the cylinder 23B and the other end of the spring 24 are attached to the body 21 by means of connection members that are conventional for the person of skill in the art, for example screws 23C, 24 (FIG. 5).

In the illustrated example, the shock absorber 23 is of the hydraulic type. In particular, the absorber fluid used in the cylinder 23B is oil.

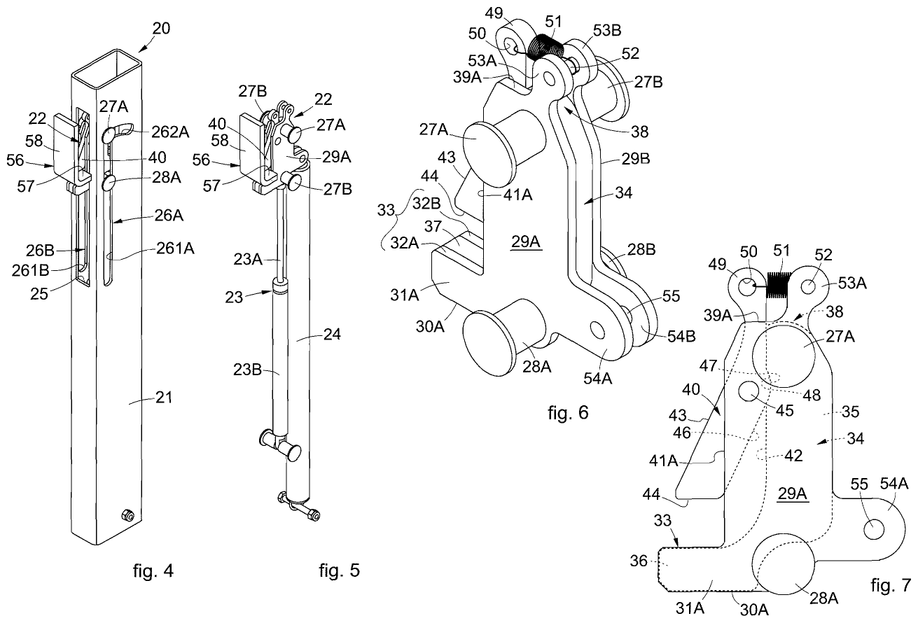

In FIG. 5 the shock absorber is shown in its rest configuration, which is extended. The slider 22 is substantially located in correspondence with one end of the tubular body 21. In this part, the body 21 comprises three slots, of which one rectilinear central slot 25 and two guide slots 26A, 26B located on two lateral surfaces of the body 21, on each part of the surface in which the central slot 25 is made (FIG. 4).

The central slot 25 is rectilinear and has a length that determines the amplitude of the travel of the slider 22, a part of which passes through the central slot (FIG. 4), when it is engaged with the leaf 12 in order to slow down its descent.

The guide slots 26A, 26B are located symmetrical to each other. Each of them comprises a first rectilinear segment 261A, 261B longitudinal to the axis of development of the body 21 and a second segment 262A, 262B inclined with respect to the first segment 261A, 261B and with a shape that is slightly curved toward the first segment 261A, 261B (FIG. 4).

In order to be guided by the guide slots 26A, 26B, the slider 22 comprises two first guide rods 27A, 27B aligned with each other and two second guide rods 28A, 28B aligned with each other, which extend perpendicularly from the slider 22 and are configured to be inserted sliding into the guide slots 26A, 26B (FIGS. 4, 5 and 6). More precisely, the first guide rods 27A, 27B, on one part, and the second guide rods 28A, 28B, on another part, are made in a single body and have a central portion which is positioned between the two plates 29A, 29B.

The slider 22 comprises a pair of shaped plates 29A, 29B with a substantially oblong shape (oriented vertically in FIG. 7) with a substantially flat lower edge 30A, 30B, and from each of which there extends a respective front protuberance 31A, 31B, located in correspondence with the lower edge 30A, 30B and which comprises a flat upper edge 32A, 32B. The upper edges 32A, 32B of the front protuberances 31A, 31B combine to form a first actuation surface 33.

The second guide rods 28A, 28B are positioned in correspondence with the lower edge 30A, 30B, substantially centered with respect to the width of the plates 29A, 29B.

Attached between the two plates 29A, 29B is a central body 34 consisting of a substantially L-shaped plate. The central body comprises a first portion 35 longitudinal to the plates 29A, 29B but with a smaller width, and a second portion 36 clamped between the front protuberances 31A, 31B and with an identical shape. The second portion 36 therefore comprises a flat upper edge 37, aligned with the upper edges 32A, 32B of the front protuberances 31A, 31B and which completes the first actuation surface 33 (FIG. 6).

The central body 34 has an upper end 38 located substantially in correspondence with the first guide rods 27A, 27B, which in turn are located in proximity to the upper edge 39A, 39B of the plates 29A, 29B (FIG. 7). The first guide rods 27A, 27B and the second guide rods 28A, 28B are longitudinally aligned with the extension of the plates 29A, 29B, that is, in a direction that is perpendicular to the first actuation surface 33 (FIG. 7).

A mobile body 40 is also inserted between the two plates 29A, 29B, mobile between an engagement position (FIGS. 6 and 7) and a disengagement position. The mobile body 40, also consisting of a plate, is located in correspondence with the front edge 41A, 41B of the plates 29A, 29B, resting on the front edge 42 of the central body 34.

The mobile body 40 has an elongated shape which, in the engagement position, has a front edge 43 that is inclined with respect to the first portion 35 of the central body 34. The mobile body 40 has a lower end that protrudes from the plates 29A, 29B. This lower end 43 has a lower edge 44 which, in the engagement position of the mobile body 40, is positioned in front of the first actuation surface 33 and is parallel thereto. The lower edge 44 of the mobile body 40 is flat and defines a second actuation surface of the slider.

The mobile body is pivoted to the plates 29A, 29B and passes from the engagement position to the disengagement position by horizontally pivoting around the pin 45. In order to aid this horizontal pivoting, in correspondence with the pin 45 the mobile body 40 has, on its rear edge 46, a crowning 47 shaped as an arc of a circle. In the same place, the central body 34 has, on its front edge 42, a recess 48 in which the crowning 47 is suitable to be temporarily housed when the mobile body 40 is in the disengagement position (FIG. 7).

In its upper part, the mobile body 40 comprises an arm 49 with a through hole 50. This arm is a connection element for a traction spring 51, which is also connected to a rod 52 located between the two plates 29A, 29B in correspondence with a pair of arms 53A, 53B that extend toward the rear from the upper edge 39A, 39B of the plates 29A, 29B (FIGS. 6 and 7). The traction spring 51 allows to keep the mobile body in the engagement position when it is not stressed.

The shaped plates 29A, 29B also each comprise a rear protuberance 54A, 54B in correspondence with a lower part thereof, between which there extends a rear rod 55 to connect one end of the traction spring 24 of the shock absorber device 20.

The free end of the piston 23A is instead attached to the central portion of the second guide rods 28A, 28B.

To drive the shock absorber device 20, it also comprises an actuation member 56 attached to the leaf 12, on the lateral support profile 12B in correspondence with which the shock absorber device 20 is positioned. The actuation member 56 comprises a plate 57 which protrudes perpendicularly from the leaf 12, and an attachment portion 58 for its attachment to the leaf 12 (FIGS. 4 and 5).

It is to be clarified that the slider 22, or in any case at least the plates 29A, 29B and the central body 34, are made of metallic material, so as to withstand the weights and stresses inherent in doors for elevators, goods elevators, platforms and suchlike, and their manual operation. As explained above the slider contains articulated parts. Such articulated parts are provided for giving mobility to some pieces, in particular the mobile body 40, as metallic material does not allow an elastic torsion, contrarily to plastic materials.

The operation of the door 10 described heretofore comprises the following steps.

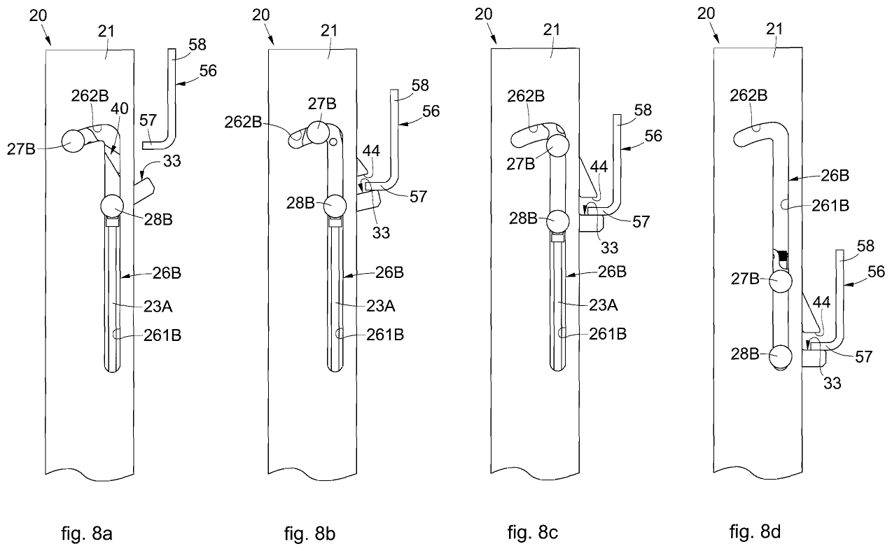

We start from a situation in which the elevator door 10 is open, that is, the leaf 12 is raised in the open position, as shown in FIG. 3. The slider 22 is in an inactive position, inclined toward the rear side of the shock absorber device 20 (FIG. 8a).

In particular, the first guide rods 27A, 27B are at the closed end of the second segment 262A, 262B of the guide slots 26A, 26B, while the second guide rods 28a, 28B are positioned in an intermediate position in the first segment 261A, 261B of the guide slots 26A, 26B. The first actuation surface 33 protrudes inclined from the tubular body 21 of the shock absorber device and can therefore intercept the travel of the plate 57 of the actuation member 56. The second actuation surface 44 is instead located inside the tubular body 21.

An operator grabs the handle 15 and manually lowers the leaf 12 to take it back to its lowered closed position. For a first phase of descent of the leaf 12, the descent is free, and the leaf 12 descends at a speed generated by the movement given by the operator. This first phase of the descent lasts so long as the plate 57 of the actuation member 56, attached to the leaf 12, comes into contact with the first actuation surface 33 of the slider 22 (FIG. 8b).

At this point, the actuation member 56 exerts a pressure on the first actuation surface 33 which causes the straightening of the slider 22 through the displacement of the first guide rods 27A, 27B from the bottom of the second segment 262A, 262B to the intersection with the first segment 261A, 261B of the guide slots 26A, 26B (FIG. 8c).

This operation determines an elongation of the traction spring 24 connected to the bottom of the slider 22, and makes the kinetic energy of the leaf and the counterweights pass to the same traction spring 24, which accumulates it as elastic potential energy. By doing so, the leaf 12 discharges part of its kinetic energy into the traction spring 24.

Once the slider 22 has been straightened, it tends to slide downward because part of the kinetic energy of the leaf 12 guides it and because the traction spring 24 pulls it in this direction.

From this moment, the actual phase of damping the descent of the leaf 12 begins, in which the downward movement of the slider 22 causes the piston 23A to slide into the cylinder 23B and determines the dissipation of all the kinetic energy of the leaf 12 and of part of the potential energy of the spring 24, until the leaf 12 reaches its lowered closed position (FIG. 8d).

When it becomes necessary to open the door 10 again, an operator lifts the leaf 12 by means of the handle 15. In the meantime, the plate 57 of the actuation member 56 strikes the second actuation surface 44 of the slider, that is, the lower edge 44 of the mobile body 40 which is kept in its engagement position thanks to the traction spring 51.

The rise of the slider 22 is not opposed by the extension of the piston 23A and cylinder 23B assembly, since such assembly used here is a unidirectional dissipator that does not offer resistance in elongation. The force exerted by the operator loads the traction spring 24 and makes the slider 22 run vertically along the first segment 261A, 261B of the guide slots 26A, 26B due to the upward thrust caused by the leaf 12 through the plate 57. When the first guide rods 27A, 27B reach the top of the first segment 261A, 261B (FIG. 8b) they are guided toward the second segment 262A, 262B of the guide slots 26A, 26B. The sliding of the first guide rods 27A, 27B along the second segment 262A, 262B of the guide slots 26A, 26B causes the pivoting of the slider 22 into the inactive position (FIG. 8a), in which the second actuation surface 44 is retracted in the tubular body 21, leaving the plate 57, and therefore the leaf 12, free to continue its upward travel. The pivoting of the slider 22 is achieved with the traction of the spring 24.

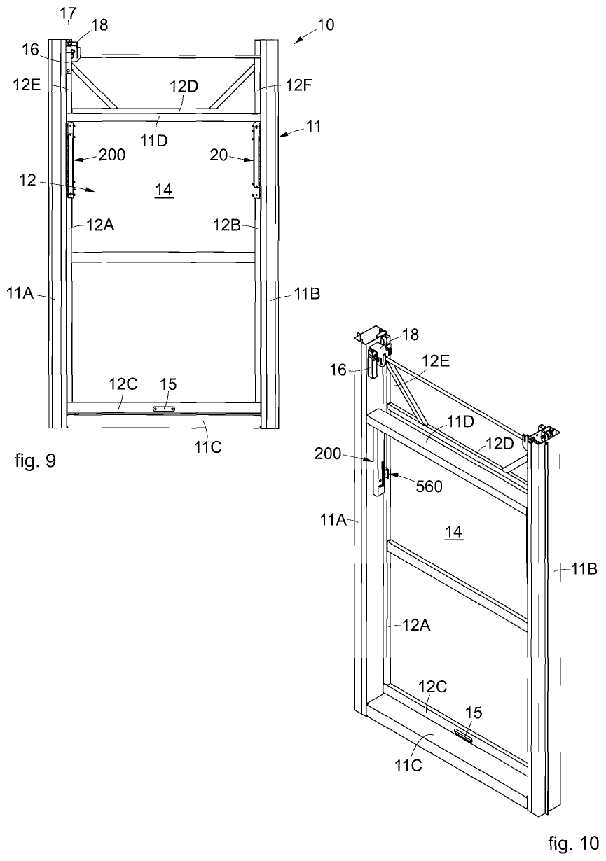

With reference to FIGS. 9 and 10, relating to a second embodiment of the door 10, this comprises, in addition to the first shock absorber device 20, a second shock absorber device 200 configured to damp the ascent of the leaf 12, in particular the last part of the ascent of the leaf 12.

The second shock absorber device 200 is identical to the first and it is located on the internal surface of the other lateral profile 11A of the frame 11. In order to damp the ascent, the second shock absorber device 200 is overturned with respect to the first. Therefore the slider 22, the central slot 25 and the guide slots 26A, 26B are positioned at the bottom (FIG. 10), while the shock absorber 23 and the traction spring 24 are above them, during use.

The operation of the second shock absorber device 200 is identical to the first, with the only difference that during damping the slider is displaced upward instead of downward.

It is clear that modifications and/or additions of parts may be made to the door 10 and to the shock absorber device 20 as described heretofore, without departing from the field and scope of the present invention, as defined by the claims.

It is also clear that, although the present invention has been described with reference to some specific examples, a person of skill in the art shall certainly be able to achieve many other equivalent forms of shock absorber device for elevator door and generic door with manually operated horizontal or vertical sliding leaf, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. A shock absorber for damping the travel of a leaf of a manually operated sliding door, the shock absorber comprising:
an abutment member configured to be struck by an actuation member; and
a shock absorber member configured to damp the travel of the abutment member in a damping direction; and
wherein the abutment member pivots between a rest position, in which the abutment member is inclined with respect to the damping direction, and an engagement position, in which the abutment member is aligned with the damping direction.

2. The shock absorber of claim 1, further comprising a guide configured to cause the pivoting of the abutment member from the rest position to the engagement position, and from the engagement position to the rest position.

3. The shock absorber of claim 2, wherein the guide means comprises at least one guide slot defining a first rectilinear segment parallel to the damping direction and a second segment inclined with respect to the first rectilinear segment.

4. The shock absorber of claim 3, wherein the abutment member comprises two guide rods configured to engage the at least one guide slot, the two guide rods being distanced from each other by a distance greater than the length of the second segment.

5. The shock absorber of claim 1, wherein the abutment member comprises a first actuation surface configured to be engaged by the actuation member when the abutment member is in the rest position or in the engagement position.

6. The shock absorber of claim 5, wherein the abutment member further comprises a second actuation surface parallel to the first actuation surface and configured to be engaged by the actuation member only when the abutment member is in the engagement position.

7. The shock absorber of claim 5, wherein, when the abutment member is in the engagement position, the first actuation surface is perpendicular to the damping direction.

8. The shock absorber of claim 1, further comprising a traction return member parallel to the damping direction and connected to the abutment member so as to exert a traction on the abutment member during travel of the abutment member.

9. The shock absorber of claim 1, wherein the shock absorber member is positioned downstream of the abutment member in the damping direction.

10. The shock absorber of claim 8, wherein the traction return member is positioned downstream of the abutment member in the damping direction.

11. The shock absorber of claim 1, wherein the shock absorber member is a unidirectional dissipator.

12. The shock absorber of claim 1, wherein the abutment member and the actuation member are made of metal.

13. A manually operated sliding door, comprising:
a leaf inside a frame, the leaf configured to be manually displaced between an open position and a closed position;
the shock absorber of claim 1, the shock absorber configured to damp the travel of the leaf toward the closed position; and
the actuation member configured to actuate the shock absorber

14. The sliding door of claim 13, wherein the shock absorber is configured to damp only a last part of the travel of the leaf toward the closed position.

15. The sliding door of claim 13, wherein the shock absorber is attached to the frame and the actuation member is attached to the leaf.

16. The sliding door of claim 13, further comprising:
a second shock absorber configured to damp the travel of the leaf toward the open position; and
a second actuation member configured to actuate the second shock absorber.

17. The sliding door of claim 16, wherein the second shock absorber is configured to damp only a last part of the travel of the leaf toward the open position.

18. The sliding door of claim 16, wherein the second shock absorber is identical to the shock absorber and overturned with respect thereto.

19. The sliding door of claim 13, wherein the door is a vertically sliding door.

20. The sliding door of claim 13, wherein the leaf slides with respect to the frame.
